(19) United States
(12) Patent Application Publication
(10) Pub. No.: US 2017/0116391 A1
(43) Pub. Date: Apr. 27, 2017

(54) HEALTH MANAGEMENT SERVICE SYSTEM ACCORDING TO EATING HABIT PATTERN AND METHOD THEREOF

(71) Applicant: SK PLANET CO., LTD., Seongnam-si (KR)

(72) Inventors: Youngmin YOON, Seoul (KR); Han Sung GWAC, Uiwang-si (KR)

(21) Appl. No.: 15/298,227

(22) Filed: Oct. 20, 2016

(30) Foreign Application Priority Data
Oct. 26, 2015 (KR) 10-2015-0148974
Oct. 27, 2015 (KR) 10-2015-0149616

(51) Int. Cl. G06F 19/00

(52) U.S. Cl. CPC G06F 19/3475; G06F 19/322

(57) ABSTRACT

The present invention relates to a health management service system and method based on an eating habit pattern, and the health management service system includes: a smart device for measuring biometric information of a user, transmitting measurement information including health condition corresponding to the measured biometric information to a management device, and receiving customized service information from the management device; and the management device for creating the customized service information according to the health condition and the eating habit pattern of the user and transmitting the customized service information to the smart device.

### CROSS REFERENCE TO RELATED APPLICATION

The present application claims the benefit of Korean Patent Application No. 10-2015-0148974 filed in the Korean Intellectual Property Office on Oct. 26, 2015 and Korean Patent Application No. 10-2015-0149616 filed in the Korean Intellectual Property Office on Oct. 27, 2015, the entire contents of which are incorporated herein by reference.

### BACKGROUND OF THE INVENTION

Field of the Invention

The present invention relates to a health management service system and method based on an eating habit pattern, more specifically, to a health management service system and method based on an eating habit pattern, which analyzes an eating habit pattern of a user based on movement information and time and position information measured by a smart device, creates customized service information according to the analyzed eating habit pattern and health condition of the user, and provides the user with the customized service information.

Background of the Related Art

A wearable device is literally a device that can be worn on a human body, and there are various kinds of wearable devices according to wearing portions, such as glasses, a watch, shoes, a ring, a belt, a band, a necklace, a headset, clothes and the like. Such wearable devices are currently in a rapidly distributed stage, and among them, wearable glasses, wearable watches and wearable bands closely related to human life and, at the same time, easy to wear form largest product groups.

On the other hand, the wearable device is also referred to as a smart device in other words. It is since that although initiation of operation by an input of a user is needed, if once the operation is initiated, various additional information can be automatically created and provided to the user thereafter. For example, if a user wearing a wearable watch desires to measure his or her heart rate, the wearable watch measures the heart rate of the user as soon as the user presses a heart rate measurement input button and creates and provides various kinds of information to the user based on the measured heart rate. Meanwhile, a lot of wearable devices which do not need initiation of operation by an input of a user also appear recently. For example, a wearable band may continuously measure a heart rate of a user although there is no initiation of operation by an input of a user, and it is highly probable that wearable devices of the future will be developed in a direction that does not need initiation of operation by an input of a user. It is since that convenience of operating a device will be increased as the input of a user is not needed.

The source of various additional information provided by the wearable device to a user is information measured from the user. Accordingly, the wearable device should necessarily install sensors for measuring various kinds of information from the user, and the more the kinds of installed sensors, the more information can be measured from the user. Accordingly, recent wearable devices tend to necessarily install a heart rate measurement sensor, a global positioning system (GPS) sensor and a walking count measurement sensor, and studies for installing various kinds of sensors in the limited inner space of the device are continued.

After measuring the information from the user through the installed sensors, the wearable device may create various additional information based on the information and provide the user with the information. For example, the wearable device may measure the current position of the user and provide information on nearby stores or products related to the interest of the user. Although the additional information can be provided through a function of the wearable device itself, since all the additional information needed for different users cannot be provided through one wearable device, applications installed in the wearable device are developed together recently. Here, an application can be regarded as a kind of application program and may perform a function of creating and providing various additional information based on the information measured through a function of the wearable device itself. In the above example, all the information about nearby stores or products related to the interest of the user can be provided by the application. That is, whenever a new application is developed, additional information that can be provided to the user through the wearable device is diversified, and thus development of applications can be regarded as a companion to go forward together with development of the wearable device itself.

Meanwhile, construction of a system capable of making a payment through a wearable device emerges as a main issue in the related industries recently. For example, although a user does not to take out his or her wallet and make a payment, the user may make a payment through a wearable device by installing a near frequency (→field) communication (NFC) function in the wearable device itself and registering a credit card of the user in an application. That is, the wearable device may perform a mobile wallet function on behalf of conventional wallets.

Meanwhile, a system for checking health condition of a user using a wearable device and providing a service of informing the health condition has already been constructed. However, the conventional system provides only health condition of a user and does not have a technique for providing a service suitable for the health condition.

Accordingly, the present invention is to propose a service for a user to confirm health condition through a wearable device and receive a service according to the health condition and an eating habit pattern of the user.

### SUMMARY OF THE INVENTION

Therefore, the present invention has been made in view of the above problems, and it is an object of the present invention to provide a health management service system and method based on an eating habit pattern, which can confirm health condition of a user and provide a customized service based on the health condition and an eating habit pattern.

Another object of the present invention is to provide a health management service system and method based on an eating habit pattern, which can analyze an eating habit pattern of a user using information measured by a smart device.

Still another object of the present invention is to provide a health management service system and method based on an eating habit pattern, which can provide an additional service by assigning a specific mission if a user uses a customized service.

The present invention may create a database of health information of a user, such as a disease of the user, physical constitution of the user, biometric information of the user, ingredients harmful to the user and the like, in the management device through a smart device, transmit information on food from the viewpoint of the user to the management device through the smart device to distinguish a food harmful to the user, recommend other substitute food beneficial to the health of the user, and provide information on coupons, points and events which can induce purchase of the food.

The technical problems to be solved by the present invention are not limited to those mentioned above, and various problems may include within a scope clearly understood by those skilled in the art from the following descriptions.

According to one aspect of the present invention, there is provided a health management service system based on an eating habit pattern, the system including: a smart device for measuring biometric information of a user, transmitting measurement information including health condition corresponding to the measured biometric information to a management device, and receiving customized service information from the management device; and the management device for creating the customized service information according to the health condition and the eating habit pattern of the user and transmitting the customized service information to the smart device.

The measurement information may include at least one of biometric information, health condition, current position information and body movement information, and the management device may analyze and store the eating habit pattern of the user based on the body movement information and time and position information.

The health management service system based on an eating habit pattern is paired with the smart device through short-range wireless communication and may further include a user device for storing and outputting the health condition measured by the smart device and the customized service information.

The customized service information may include at least one of information on coupons or points of a food store and information on coupons suitable for the health condition of the user.

According to another aspect of the present invention, there is provided a management device including: a communication unit for communicating with a smart device; an eating habit pattern analysis unit for selecting a preferred food store of a user using position information according to movement of the smart device, and analyzing and storing an eating habit pattern using the selected preferred food store; and a customized service unit for creating customized service information according to health condition and the eating habit pattern of the user transmitted from the smart device and transmitting the created customized service information to the smart device.

The eating habit pattern analysis unit may analyze the eating habit pattern based on user's body movement information and time and position information transmitted from the smart device.

According to still another aspect of the present invention, there is provided a smart device including: a communication unit for communicating with a management device; a sensor unit for measuring biometric information of a user; and a control unit for determining health condition of the user from the measured biometric information, transmitting measurement information including the health condition to the management device through the communication unit, and receiving customized service information according to the health condition from the management device.

The measurement information may include at least one of biometric information, health condition, current position information and movement information.

The control unit may analyze the eating habit pattern of the user based on the movement information and the time and position information measured by the sensor unit and create customized service information according to the health condition and the eating habit pattern.

Meanwhile, the health management service system and method based on an eating habit pattern′ may be implemented in the form of a program and recorded in a recording medium that can be read by an electronic device or distributed through a program download management device (a server or the like).

To accomplish the above objects, a smart device of the present invention may include: a camera unit for photographing a food; an identification information extraction unit for extracting identification information allowing a server to specify the photographed food; a communication unit for transmitting the identification information to the management device and receiving information on ingredients harmful to the user, contained in a food matching to the identification information, and/or information on substitute food from the management device; and a display unit for outputting the received information on ingredients harmful to the user and/or information on substitute food.

At this point, the identification information extraction unit extracts at least any one of a food name, a food image, a bar code and a QR code as the identification information.

In addition, the smart device of the present invention may further include a biometric information measurement unit for measuring biometric information of the user.

At this point, the biometric information measurement unit is mounted on the body of the user to be separate from the other configurations of the smart device.

In addition, the biometric information is at least one of temperature, heartbeat rate, blood sugar level, blood pressure and body fat.

In addition, the smart device of the present invention may further include an input unit for inputting health information of the user, including any one of a disease of the user, physical constitution, biometric information and ingredients harmful to the user, as information to be transmitted to the management device by the communication unit.

A customized management device may include: a database for storing health information of a user, including any one of a disease of the user, physical constitution of the user, biometric information of the user and ingredients harmful to the user, ingredient information of a food and identification information specifying the food; an identification information matching unit for extracting, from the database, ingredient information of a food matching to the identification information received from a smart device; a food recommendation unit for extracting information on ingredients that the user cannot take from the food and/or information on substitute food by comparing the ingredient information of the food with the health information of the smart device user; and a server communication unit for receiving the identification information from the smart device and transmitting information on ingredients harmful to the user and/or the information on substitute food.

At this point, the identification information is at least any one of a food name, a food image, a bar code and a QR code.

In addition, if the food contains an ingredient harmful to the user, the food recommendation unit selects a food containing ingredients other than the harmful ingredient as much as possible as a substitute food.

In addition, if the food is a food unsuitable for the disease or physical constitution of the user, the food recommendation unit selects a substitute food containing nutritious contents similar to those of the food.

In addition, the food recommendation unit extracts at least one of information on a store handling the substitute food and information on coupons, points and events.

A health management service system based on an eating habit pattern of the present invention may include: a smart device for photographing a food, extracting and transmitting identification information to a management device allowing the management device to specify the photographed food, and receiving and outputting information on ingredients harmful to the user, contained in a food matching to the identification information, and/or information on substitute food from the management device; and the management device for extracting ingredient information of a food matching to the identification information received from the smart device from the database, extracting information on ingredients that the user cannot take from the food and/or information on substitute food by comparing the ingredient information of the food with health information of the smart device user, and transmitting the extracted information to the smart device.

At this point, the health management service system based on an eating habit pattern may further include a user device for receiving information on ingredients that the user cannot take from the food and/or information on substitute food extracted by the management device, receiving at least one piece of information among information on a store handling the substitute food and information on coupons, points and events from the management device, and making a payment.

A health management service method based on an eating habit pattern of the present invention may include: (a) photographing a food by a smart device; (b) extracting, by the smart device, identification information allowing the management device to specify the photographed food; (c) transmitting, by the smart device, the identification information to the management device; (d) extracting, from the database by the management device, ingredient information of a food matching to the identification information received from the smart device; (e) extracting, by the management device, information on ingredients that the user cannot take from the food and/or information on substitute food by comparing the ingredient information of the food with health information of the smart device user; and (f) outputting, by the smart device, the received information on ingredients harmful to the user and/or information on substitute food.

At this point, the health management service method based on an eating habit pattern of the present invention may further include, after step (e), the steps of: transmitting, by the management device, the information on ingredients that the user cannot take from the food and the information on substitute food; transmitting, by the management device, at least one piece of information among information on a store handling the substitute food and information on coupons, points and events; and receiving, by the user device, the information and making a payment.

A health management service method based on an eating habit pattern in a smart device of the present invention may include the steps of: (a) photographing a food; (b) extracting identification information allowing the management device to specify the photographed food; (c) transmitting the identification information to the management device; (d) receiving information on ingredients harmful to the user, contained in a food matching to the identification information, and/or information on substitute food from the management device; and (f) outputting the received information on ingredients harmful to the user and/or information on substitute food.

At this point, step (b) extracts at least any one of a food name, a food image, a bar code and a QR code.

In addition, the customized method in the smart device may further include the step of measuring biometric information of the user.

At this point, the step of measuring the biometric information of the user mounts the biometric information measurement unit 150′ on the body of a user to be separate from the other configurations of the smart device.

In addition, the biometric information is at least one of temperature, heartbeat rate, blood sugar level, blood pressure and body fat.

In addition, the customized method in the smart device may further include the step of inputting health information of the user, including any one of a disease of the user, physical constitution, biometric information and ingredients harmful to the user, as information to be transmitted to the management device.

A health management service method based on an eating habit pattern in a management device of the present invention may include the steps of: (a) extracting, from the database, ingredient information of a food matching to the identification information received from the smart device; (b) extracting information on ingredients that the user cannot take from the food and/or information on substitute food by comparing the ingredient information of the food with health information of the smart device user; and (c) transmitting information on ingredients harmful to the user and/or the information on substitute food.

At this point, the identification information is at least any one of a food name, a food image, a bar code and a QR code.

In addition, if the food contains ingredients harmful to the user, step (b) selects a food containing ingredients other than the harmful ingredients as much as possible as a substitute food.

In addition, if the food is a food unsuitable for the disease or physical constitution of the user, step (b) selects a substitute food containing nutritious contents similar to those of the food.

In addition, step (b) extracts at least one of information on a store handling the substitute food and information on coupons, points and events.

### BRIEF DESCRIPTION OF THE DRAWINGS

FIG. 1 is a view showing a health management service system based on an eating habit pattern according to an embodiment of the present invention.

FIG. 2 is a block diagram schematically showing the configuration of a smart device according to an embodiment of the invention.

FIG. 3 is a block diagram schematically showing the configuration of a management device according to an embodiment of the invention.

FIG. 4 is a view showing a health management service method based on an eating habit pattern according to an embodiment of the present invention.

FIG. 5 is a flowchart illustrating a method of providing a health management service by a smart device based on an eating habit pattern according to an embodiment of the present invention.

FIG. 6 is a flowchart illustrating a health management service providing method based on an eating habit pattern by a management device according to an embodiment of the present invention.

FIG. 7 is a view showing a health management service method based on an eating habit pattern according to another embodiment of the present invention.

FIG. 8 is a flowchart illustrating a health management service method based on an eating habit pattern by a smart device according to another embodiment of the present invention.

FIG. 9 is a reference view schematically showing a process of implementing a health management service system based on an eating habit pattern according to an embodiment of the present invention.

FIG. 10 is a view showing the configuration of a health management service system based on an eating habit pattern according to an embodiment of the present invention.

FIG. 11 is a configuration view showing function blocks of a smart device according to one embodiment of the invention.

FIG. 12 is a configuration view showing function blocks of a customized management device according to an embodiment of the invention.

FIG. 13 is a flowchart illustrating a health management service method based on an eating habit pattern according to another embodiment of the present invention.

FIG. 14 is a flowchart illustrating a health management service method based on an eating habit pattern in a smart device according to another embodiment of the present invention.

FIG. 15 is a flowchart illustrating a health management service method based on an eating habit pattern in a management device according to another embodiment of the present invention.

### DESCRIPTION OF SYMBOLS

100: Smart device
110: Sensor unit
120, 250: Control unit
130: Storage unit
140, 210: Communication unit
200: Management device
220: Database
230: Eating habit pattern analysis unit
240: Customized service unit
300: User device
100′: Smart device
110′: Camera unit
120′: Identification information extraction unit
130′: Communication unit
140′: Display unit
150′: Biometric information measurement unit
160′: Input unit
200′: Management device
210′: Database
220′: Identification information matching unit
230′: Food recommendation unit
240′: management device communication unit
300′: User device

### DETAILED DESCRIPTION OF THE PREFERRED EMBODIMENT

Hereinafter, a ‘health management service system and method based on an eating habit pattern’ according to the present invention will be described in detail with reference to the accompanying drawings. The disclosed embodiments are provided to enable those skilled in the art to easily understand the scope of the present invention, and the present invention is not limited by such embodiments. Moreover, matters illustrated in the drawings are schematized in order to describe or explain the embodiments of the present invention more easily and hence may be different from actually embodied forms.

Meanwhile, the constitutional components expressed below are merely examples for implementing the present invention. Accordingly, other constitutional components may be used in other implementations of the present invention without departing from the spirit and scope of the present invention.

In addition, although each constitutional component may be implemented only in a pure hardware or software configuration, it also can be implemented by combining various hardware or software configurations performing the same function. In addition, two or more constitutional components may be implemented together by one piece of hardware or software.

In addition, the expression of ‘including’ a component is an expression of an ‘open type’ which merely refers to existence of a corresponding component, and it should not be construed as precluding additional components.

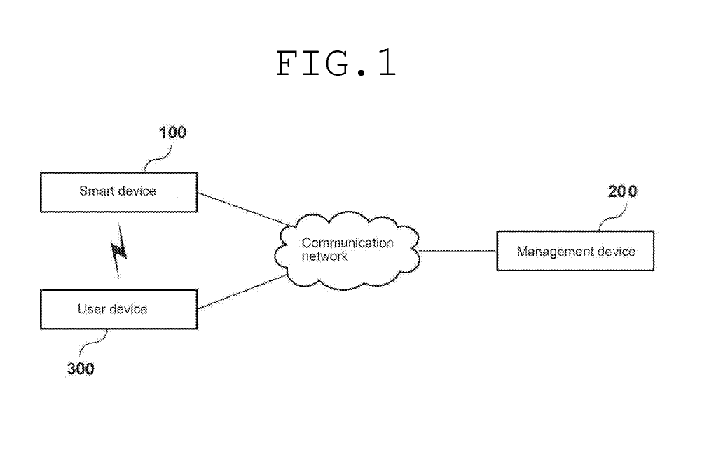

FIG. 1 is a view showing a health management service system based on an eating habit pattern according to an embodiment of the present invention.

Referring to FIG. 1, a health management service system based on an eating habit pattern includes a smart device 100 and a management device 200, and these are connected through a communication network.

The smart device 100 measures biometric information of a user, transmits measurement information including health condition corresponding to the measured biometric information to the management device 200, and receives customized service information from the management device 200. Here, the measurement information may include biometric information, health condition, current position information, smart device identification information, authentication information and the like, and the health condition is created based on the measured biometric information and can be expressed as a pulse rate, a blood pressure and the like, and the biometric information may include a pulse rate, a blood pressure, a blood sugar level, blood oxygen saturation (SpO2) and the like. The smart device 100 may measure the biometric information by sensing basic physical properties such as current, voltage, resistance and the like containing biometric measurement information such as a pulse rate, a blood pressure and the like.

In addition, the smart device 100 may measure time information, position information and movement information to analyze the eating habit pattern of the user and transmit the measured information to the management device 200. The time information is information for analyzing a mealtime (breakfast, lunch or dinner), the position information is information for analyzing a home, a food store such as an eatery or the like, and the movement information is information for analyzing movement of the user's body, and for example, movement of an arm can be used as information for analyzing the eating speed or a pattern of taking food (e.g., chopsticks, spoons, forks or the like).

In addition, if the customized service information received from the management device 200 is used, the smart device 100 receives mission information from the management device 200. Here, the mission information is information for improving health condition of the user, which can be, for example, information for continuous health care by providing additional points or additional discount coupons if the user loses 5 kg of weight.

If the user uses the customized service information, an additional service is provided by assigning a mission, and thus health is naturally managed while using a corresponding service, and the user may get additional benefits. In addition, the problem of user's health can be preferentially improved through successive missions.

Such a smart device 100 means a device that can be worn on a human body, and there are various kinds of wearable devices according to wearing portions, such as glasses, a watch, shoes, a ring, a belt, a band, a necklace, a headset, clothes and the like.

If the measurement information is received from the smart device 100, the management device 200 creates customized service information according to the health condition and the eating habit pattern of the user and transmits the customized service information to the smart device 100. Here, the customized service information may include information on coupons or points of a preferred food store or information on coupons suitable for the health condition of the user and may be formed of various media such as text, a sound, an image a moving image, multimedia and the like. Like this, the management device 200 transmits the customized service information to the smart device 100 so that the user may confirm the customized service information and take into account the customized service information for health management. In an embodiment, the management device 200 may be a management server.

For example, if the mealtime of the user shows an irregular eating habit pattern, the management device 200 confirms health condition of the user and provides customized service information such as coupons of food stores for improving health condition of the user at the meal time, coupons for healthy food and the like. In addition, if the blood pressure of the user is high, the management device 200 may select a store selling food good for the blood pressure among preferred food stores and provide customized service information such as coupons, point accumulation and the like of the selected store. In addition, if the blood sugar level of the user is high, the management device 200 may select a store selling food good for the control of the blood sugar level among the preferred food stores and provide customized service information such as coupons, point accumulation and the like of the selected store.

The management device 200 analyzes the eating habit pattern of the user based on the movement information and the time and position information transmitted from the smart device 100. That is, the management device 200 may analyze the mealtime (breakfast, lunch and dinner) of the user using the time information, analyze an eating place such as a home, a restaurant or the like using the position information, and analyze eating speed or a pattern of taking a specific food (e.g., chopsticks, spoons, forks or the like) using movement of an arm. The mealtime, the eating place, the eating speed, the pattern of taking a specific food or the like analyzed like this may be an eating habit pattern.

In addition, the management device 200 provides a service for improving the eating habit through the eating habit pattern of the user. The management device 200 provides an optimum personal service to induce the eating habit pattern of the user to be close to a standard behavior pattern. For example, the management device 200 may provide a service or the like for reducing the eating speed so that the user may maintain an eating speed corresponding to the standard behavior pattern.

In addition, the management device 200 may inquire the user whether or not to eat out by recommending the user a menu most suitable for the health condition of the user transmitted from the smart device 100. If the user shows an intention of eating out through the smart device 100 as a response, the management device 200 may be applied with current position information and recommend restaurants in the neighborhood, and the user may select a restaurant.

In addition, the management device 200 may provide a safe and effective customized service recommending a menu and restaurants in the neighborhood suitable for the disease and preference of the user by utilizing the body and health condition of the user.

As described above, since a display unit is provided in the smart device 100, the smart device 100 may display the customized service information transmitted from the management device 200, the measured biometric information and the like. However, the display unit may not be provided in the smart device 100. In this case, the health management service system based on an eating habit pattern may further include a user device 300, and the user device 300 may be, for example, a user terminal.

As another embodiment of the present invention, the health management service system based on an eating habit pattern may further include a user device 300 for storing and outputting the biometric information measured by the smart device 100 and the customized service information received from the management device 200.

Accordingly, in the present invention, since even the user device 300, as well as the smart device 100 and the management device 200, is also connected, biometric information is provided to the user even while the user does not wear the smart device 100, and the user may be provided with the customized service information from the management device 200 to further easily access various products.

The smart device 100 may periodically measure and estimate health information of the user by exchanging data with the user device 300.

The smart device 100 may transmit the measured biometric information to the user terminal (e.g., a smart phone) paired with the smart device 100. For example, the smart device 100 may transmit and receive data using a short-range communication network such as an NFC or Bluetooth network. At this point, the measurement information may be transmitted from the user device 300 to the management device 200 through the communication network. The smart device 100 may receive the customized service information created by the management device 200 from the management device 200, and the received customized service information may be transmitted from the smart device 100 to the user device 300.

The user device 300 includes a Personal Digital Assistant (PDA), a smart phone, a cellular phone, a Personal Communication Service (PCS) phone, a Global System for Mobile (GSM) phone, a Wideband CDMA (W-CDMA) phone, a CDMA-2000 phone, a Mobile Broadband System (MBS) phone and the like which can be applied to various wired and wireless environments. Here, although the user device 300 may represent a small portable device, embodiments of the present invention will not be specially limited thereto since the user device 300 can be referred to as a mobile communication terminal if it includes a camcorder, a laptop computer or the like.

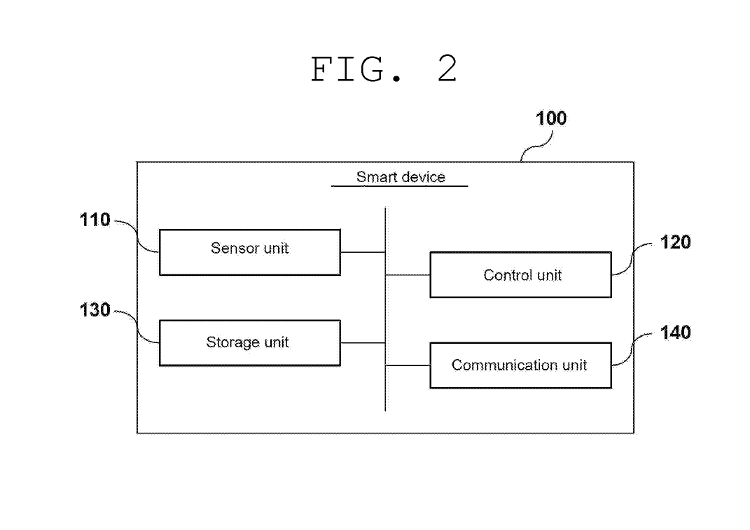

FIG. 2 is a block diagram schematically showing the configuration of a smart device according to an embodiment of the invention.

Referring to FIG. 2, a smart device 100 includes a sensor unit 110, a control unit 120, a storage unit 130 and a communication unit 140.

The sensor unit 110 is mounted on the smart device 100 and measures biometric information of a user. Here, the biometric information may include a pulse rate, a blood pressure, a blood sugar level, blood oxygen saturation (SpO2) and the like. In this case, the sensor unit 110 senses basic physical properties such as current, voltage, resistance and the like and converts the basic physical property into a data of a desired form. The sensor unit 110 includes corresponding measurement sensors according to the types of measurement targets desired to be measured and includes, for example, a pulse sensor, a blood pressure sensor, a blood sugar sensor and the like. Since the sensor unit 110 periodically or continuously senses the measured biometric information and transmits an electrical signal corresponding thereto to the control unit 120, the user may confirm a result through the smart device 100 or a user device or the like connected to the smart device 100, and, in an emergency situation, the user terminal connected to the smart device 100 may directly inform the result to the outside on behalf of the user.

In addition, the sensor unit 110 measures position information and movement, in addition to the biometric information, of the user. In this case, the sensor unit 110 may include a biometric information sensor, a position sensing sensor and a motion sensing sensor. The biometric information sensor is a sensor for measuring biometric information of a user and may include, for example, a pulse sensor, a blood pressure sensor and the like. The position sensing sensor is a sensor for measuring the current position of a user and may include, for example, a GPS sensor and the like. The motion sensing sensor is a sensor for measuring a motion of an arm of a user and may include, for example, an acceleration sensor and the like. The acceleration sensor may sense a motion of a user using a three-axis acceleration sensor axis and, for example, senses movement of an arm for sensing the eating speed among the eating patterns of the user. The sensor unit 110 recognizes movement of an eating arm. Here, the movement of an eating arm may include the number of up-down movements, speed and the like of the user's arm, and it may be any one or more of the movements of the arm accompanied while the user eats.

Like this, the position information and the movement information measured by the sensor unit 110 are information for analyzing the eating habit pattern of a user, and the time information is information for analyzing a mealtime (breakfast, lunch or dinner), the position information is information for analyzing a home, a food store such as an eatery or the like, and movement of an arm can be used as information for analyzing the eating speed or a pattern of taking food (e.g., chopsticks, spoons, forks or the like).

The control unit 120 determines health condition of a user from the biometric information measured by the sensor unit 110, transmits measurement information including health condition to the management device through the communication unit 140, and receives customized service information from the management device. The measurement information may include biometric information, health condition, current position information, smart device identification information, authentication information and the like, and the health condition is created based on the measured biometric information and can be expressed as a pulse rate, a blood pressure and the like, and the biometric information may include a pulse rate, a blood pressure, a blood sugar level, blood oxygen saturation (SpO2) and the like.

In addition, the control unit 120 transmits the measurement information including the biometric information, the movement information and the position information measured by the sensor unit 110 to the management device through the communication unit 140.

In addition, the control unit 120 determines whether or not the health condition of the user is normal by comparing the biometric information measured by the sensor unit 110 with previously stored biometric reference information. As an example, it is configured such that if the heart rate goes out of a lower threshold value or an upper threshold value included in the biometric reference information, the control unit 120 determines health condition of the user's heart as abnormal. As another example, if the heart rate change pattern goes out of a range allowing change of the pattern included in heartbeat reference information, the control unit 120 may determine the health condition of the user's heart as abnormal.

If the customized service information received from the management device is used, the control unit 120 receives mission information from the management device. The customized service information includes a product discount coupon, point accumulation, a product providing coupon, information suitable for the health condition of the user or the like of a preferred food store, and the user may use the coupon at the store.

According to another embodiment of the present invention, the control unit 120 may analyze the eating habit pattern of a user using at least one of the position information, the movement information and the time information measured by the sensor unit 110 and create customized service information according to the health condition of the user and the analyzed eating habit pattern.

That is, the control unit 120 may store the position information measured by the sensor unit 110, select a preferred food store of the user using the stored position information or visited food stores of the user, and analyze an eating habit pattern using the selected preferred food store. Here, the food store may be a store selling food, such as a restaurant, a cafeteria and the like. That is, if the position information indicates a food store, the control unit 120 stores the food store and selects a food store most frequently visited among the stored food stores as a preferred food store. Then, the control unit 120 acquires selling food information such as calories or the like of a food sold at each preferred food store. At this point, if information on the food sold at each food store is registered, the control unit 120 may use the stored information, or if the information is not registered, the control unit 120 may acquire information on the food from a corresponding store. Here, the selling food information may include a food name, calories, raw food materials and the like. The control unit 120 may determine whether or not a food or a food store is suitable for the user based on the selling food information of the preferred food store and the health condition of the user and output a result of the determination.

The control unit 120 may analyze the eating habit pattern of the user based on the movement information and the time and position information measured by the sensor unit 110. That is, the control unit 120 may analyze the mealtime (breakfast, lunch and dinner) of the user using the time information, analyze an eating place such as a home, a restaurant or the like using the position information, and analyze eating speed or a pattern of taking a specific food (e.g., chopsticks, spoons, forks or the like) using movement of an arm. The mealtime, the eating place, the eating speed, the pattern of taking a specific food or the like may be an eating habit pattern. The mealtime, the eating place, the eating speed, the pattern of taking a specific food or the like analyzed like this may be an eating habit pattern.

Such a control unit 120 may include at least one arithmetic unit, and, here, the arithmetic unit may be a general-purpose central processing unit (CPU), a programmable device element (CPLD or FPGA) implemented to be suitable for a specific purpose, an application specific integrated circuit (ASIC) or a microcontroller chip.

The storage unit 130 is a configuration for storing data related to operation of the smart device 100. Here, the storage unit 130 may use a publicized storage medium and may use one or more of publicized storage media such as ROM, PROM, EPROM, EEPROM, RAM and the like.

Particularly, body reference information, which is a reference for determining whether or not the health condition of the user is normal, is stored in the storage unit 130. The body reference information is a reference for determining health condition of a user and may be diversely configured. As an example, heartbeat reference information may be configured to include a lower threshold value and an upper threshold value by adding and subtracting a predetermined value based on a heartbeat rate of a user in normal condition. If the heartbeat rate of a user is lower than the lower threshold value or exceeds the upper threshold value, the user may be determined as being in an emergency situation of an abnormal heart health condition. As another example, the heartbeat reference information may be configured to include a change pattern unique to a heartbeat rate of a user and an allowed deviation range of the unique change pattern. In this case, if the heartbeat rate change pattern of the user goes out of the allowed deviation range, the user may be determined as being in an emergency situation of an abnormal heart health condition.

An application (or an applet) or the like capable of performing the health management service based on an eating habit pattern can be stored in the storage unit 130, and the stored information may be selected by the control unit 150 as needed.

The control unit 120 may store an application (or an applet) capable of performing a health management service process based on an eating habit pattern in the storage unit 130 and drive and control the application to output customized service information provided by the management device.

The communication unit 140 is a configuration for exchanging data with various electronic devices. Particularly, the communication unit 140 can be connected two or more devices and transmit and receive various kinds of information such as measurement information, customized service information, mission information and the like.

The smart device 100 according to the present invention may further include a display unit (not shown) for displaying various kinds of information related to the operation of the smart device 100. Particularly, the display unit may display various kinds of information such as the biometric information measured by the sensor unit 110, the customized service information, the mission information and the like. The display unit may be implemented through various display devices including an LCD, an LED and the like.

In addition, the smart device 100 according to the present invention may further include a power supply unit (not shown) for supplying power. In addition, the smart device of the present invention may further include a short-range communication unit (not shown) for performing short-range wireless communication with a user device possessed by the user. The short-range communication unit may operate according to various specifications such as Wi-Fi communication, Bluetooth communication, Zigbee communication, infrared communication (IrDA), Radio Frequency (RF) communication including Ultra High Frequency (UHF) communication and Very High Frequency (VHF) communication, Ultra Wide Band (UWB) communication and the like.

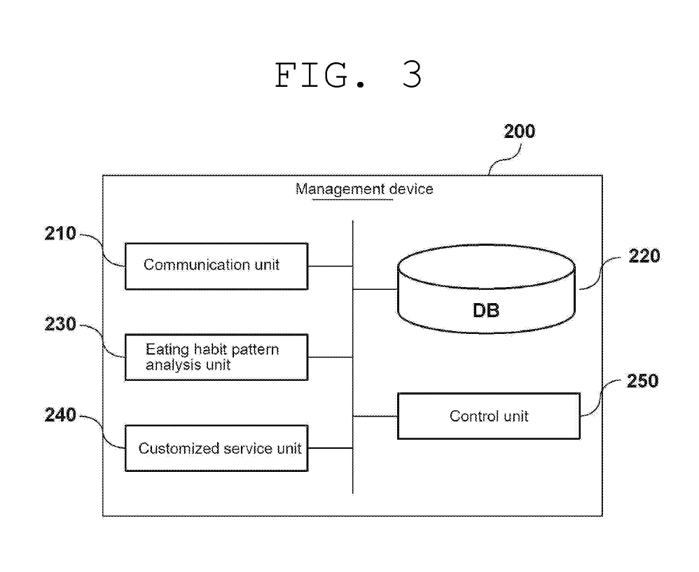

FIG. 3 is a block diagram schematically showing the configuration of a management device according to an embodiment of the invention.

Referring to FIG. 3, the management device 200 includes a communication unit 210, a database 220, an eating habit pattern analysis unit 230, a customized service unit 240 and a control unit 250.

The communication unit 210 may receive measurement information including biometric information from the smart device through a communication network and transmit customized service information created by the control unit 250 to the smart device. Here, the communication network includes both wired communication and wireless communication, and the smart device and the management device 200 are connected to each other through the communication network.

User information (e.g., a name, user identification information, smart device identification information and the like), preferred food stores, eating habit patterns, biometric information, health condition, position information and the like are stored in the database 220. In addition, customized service information provided to the user, information on the services used by the user, mission information and the like are stored in the database 220.

The database 220 is an apparatus for storing data and basically stores data such as environmental variables or the like used for search, classification, analysis and the like, and since the functions of the database 220 can be implemented using general techniques, detailed descriptions on the implementation will be omitted.

The eating habit pattern analysis unit 230 selects a preferred food store of the user using the position information or visited food stores of the user stored in the database 220, analyzes an eating habit pattern using the selected preferred food store, and stores the analyzed eating habit pattern in the database 220. Here, the food store may include stores selling food, such as an eatery, a restaurant, a cafeteria and the like. That is, if the position information indicates a food store, the eating habit pattern analysis unit 230 stores the food store and selects a food store most frequently visited among the stored food stores as a preferred food store. Then, the eating habit pattern analysis unit 230 acquires selling food information such as calories or the like of a food sold at each preferred food store. At this point, if information on the food sold at each food store is registered, the eating habit pattern analysis unit 230 may use the stored information, or if the information is not registered, the eating habit pattern analysis unit 230 may acquire information on the food from a corresponding store. The selling food information may include a food name, calories, raw food materials and the like. The eating habit pattern analysis unit 230 determines whether or not a food or a food store is suitable for the user based on the selling food information of the preferred food store and the health condition of the user and stores a result of the determination in the database 200 or transmit the result to the smart device.

According to another embodiment of the present invention, the eating habit pattern analysis unit 230 may analyze the eating habit pattern of the user based on the movement information and the position information of the user transmitted from the smart device. That is, the eating habit pattern analysis unit 230 analyzes the mealtime (breakfast, lunch and dinner) of the user using the time information and analyzes a food store for eating, such as a home, a restaurant or the like, using the position information. In addition, the eating habit pattern analysis unit 230 may compare the movement information with a preset reference movement and analyze eating speed of the user based on a result of the comparison. The eating habit pattern analysis unit 230 analyzes an eating habit pattern by combining the analyzed mealtime, food store and eating speed. For example, the eating habit pattern may be analyzed such that user A eats at lunch time at store A three times a week.

Like this, the eating habit pattern analysis unit 230 may determine a mealtime, a snack time and the like using the time information, determine a food store using the position information and determine eating speed using movement of an arm.

The eating habit pattern analysis unit 230 may compare the analyzed eating habit pattern with health condition of the user and inform the user of eating habit problems of the user. That is, the eating habit pattern analysis unit 230 may determine whether or not a food or a food store is suitable for the user based on the selling food information of the preferred food store and the health condition of the user and inform the user of a result of the determination.

The customized service unit 240 creates customized service information according to the eating habit pattern analyzed by the eating habit pattern analysis unit 230 and the health condition of the user and transmits the customized service information to the smart device. That is, the customized service unit 240 creates customized service information including coupons or point accumulation of a food store suitable for the user, healthy food coupons and the like based on the eating habit pattern, the preferred food store and the health condition and transmits the created customized service information to the smart device in a push form.

For example, if the mealtime of the user shows an irregular eating habit pattern, the customized service unit 240 confirms health condition of the user and provides customized service information such as coupons of food stores for improving health condition of the user at the meal time, coupons for healthy food and the like. In addition, if the blood pressure of the user is high, the customized service unit 240 may select a store selling food good for the blood pressure among the preferred food stores and provide customized service information such as coupons, point accumulation and the like of the selected store.

In addition, the customized service unit 240 may confirm a mealtime based on the eating habit pattern, select a food store suitable for the health condition of the user among the preferred food stores when a mealtime arrives, and provide customized service information including coupons or point accumulation of the selected food store, healthy food coupons and the like. For example, if the blood sugar level of the user is high, the customized service unit 240 may select a store selling food good for the blood sugar among the preferred food stores and provide customized service information such as coupons, point accumulation and the like of the selected store.

In addition, if the user uses the coupon, points or the like included in the customized service information, the customized service unit 240 creates and provides mission information to the smart device. For example, when the user uses a discount coupon included in the customized service information, the customized service unit 240 provides a mission for improving the health condition of the user in the form of a push message or the like. Here, the mission induces continuous health care by providing additional points or additional discount coupons if the user loses 5 kg of weight. Through successive missions, the problem of the user's health can be preferentially improved.

In addition, the customized service unit 240 provides a service for improving the eating habit through the eating habit pattern of the user. For example, the customized service unit 240 provides the user with a service or the like for reducing the eating speed so that the user may maintain an eating speed corresponding to the standard behavior pattern.

In addition, the customized service unit 240 may inquire the user whether or not to eat out by recommending the user a menu most suitable for the health condition of the user. If the user shows an intention of eating out through the smart device as a response, the customized service unit 240 may be applied with current position information and select restaurants in the neighborhood and provide the user with customized service information including coupons or point accumulation of the selected restaurants, and the user may select a restaurant.

In addition, the customized service unit 240 may provide a safe and effective customized service recommending a menu and restaurants in the neighborhood suitable for the disease and preference of the user by utilizing the body and health condition of the user.

Meanwhile, the eating habit pattern analysis unit 230 and the customized unit 240 can be implemented by a processor or the like needed to execute a program on a computing device. Like this, each of the eating habit pattern analysis unit 230 and the customized unit 240 can be implemented by a physically independent configuration or implemented as a functionally separate form in a processor.

The control unit 250 is a configuration for controlling operation of various constitutional components of the management device 200 including the communication unit 210, the database 220, the eating habit pattern analysis unit 230 and the customized unit 240.

Such a control unit 250 may include at least one arithmetic unit, and, here, the arithmetic unit may be a general-purpose central processing unit (CPU), a programmable device element (CPLD or FPGA) implemented to be suitable for a specific purpose, an application specific integrated circuit (ASIC) or a microcontroller chip.

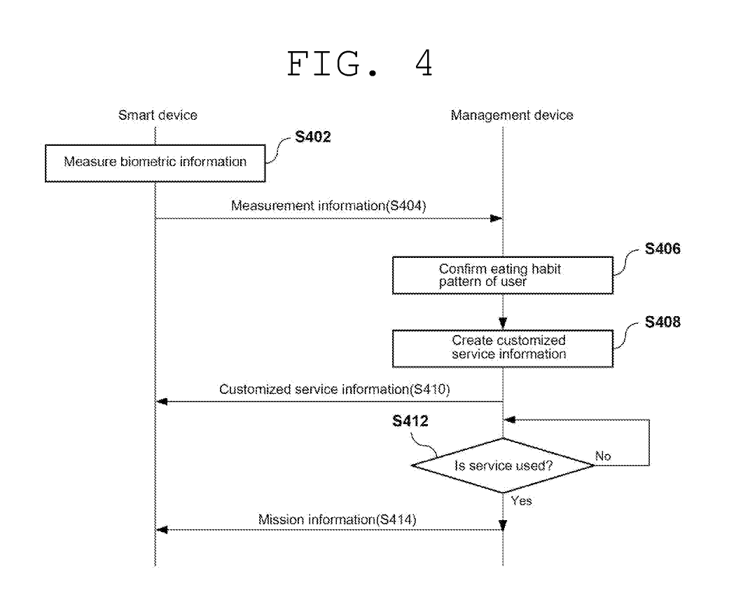

FIG. 4 is a view showing a health management service method based on an eating habit pattern according to an embodiment of the present invention.

Referring to FIG. 4, the smart device measures biometric information of a user (step S402) and transmits measurement information including the measured biometric information to the management device (step S404). Here, the measurement information may include biometric information, health condition corresponding to the biometric information, position information, movement information, smart device identification information, time information and the like.

The management device confirms the eating habit pattern and the preferred food store of the user (step S406) and creates customized service information based on the eating habit pattern, the preferred food store and the health condition (step S408). That is, if a mealtime (a snack time) arrives on the basis of the eating habit pattern, the management device selects a preferred food store preferred by the user or suitable for the health condition of the user. Then, the management device creates customized service information including coupons, points or the like of the selected preferred food store.

The management device transmits the created customized service information to the smart device (step S410), and if the customized service information is used by the user (step S412), the management device creates mission information for improving the health condition of the user and transmits the mission information to the smart device (step S414). That is, if the user uses the provided customized service, the management device provides an additional service by assigning a specific mission.

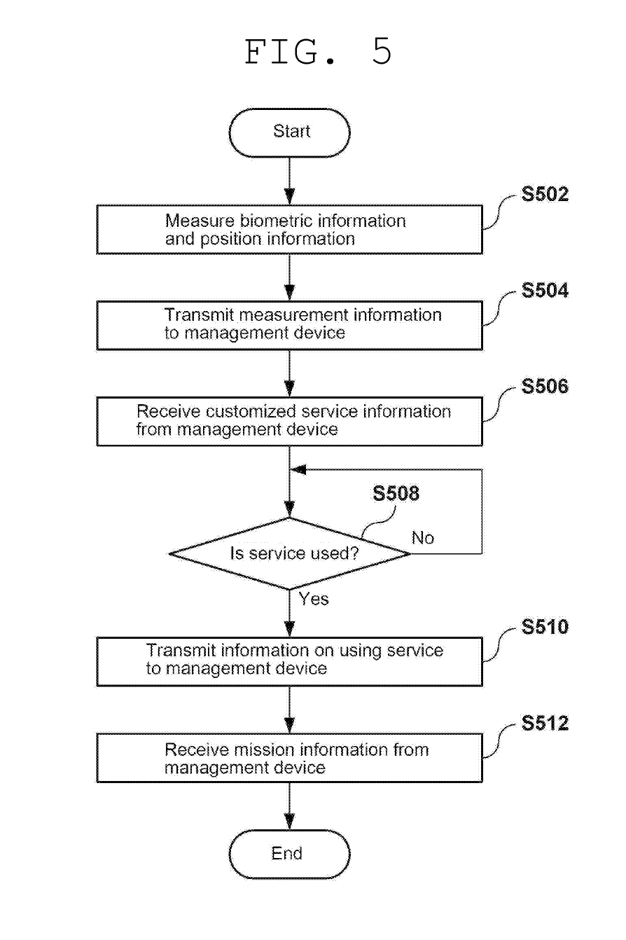

FIG. 5 is a flowchart illustrating a method of providing a health management service by a smart device based on an eating habit pattern according to an embodiment of the present invention.

Referring to FIG. 5, the smart device measures biometric information and position information of a user (step S502) and transmits measurement information thereof to the management device (step S504). The measurement information includes biometric information, position information, health condition, time information, smart device identification information and the like.

Then, the smart device receives customized service information created based on the eating habit pattern, the preferred food store and the health condition of the user from the management device (step S506). The smart device receives the customized service information in a push form, and the user may use a coupon or accumulate points included in the customized service information.

If the user uses the customized service information (step S508), the smart device transmits information on using the service to the management device (step S510) and receives mission information from the management device (step S512). If the user performs the mission, the user may receive an additional service.

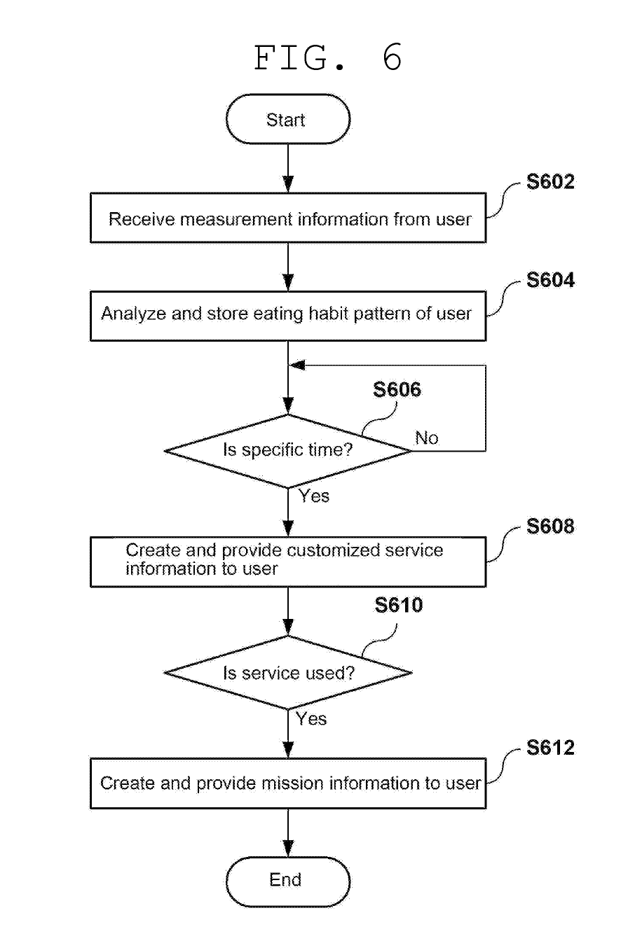

FIG. 6 is a flowchart illustrating a health management service providing method based on an eating habit pattern by a management device according to an embodiment of the present invention.

Referring to FIG. 6, the management device collects measurement information including position information and biometric information from the smart device (step S602) and analyzes and stores an eating habit pattern of the user using the collected measurement information (step S604). That is, the management device may select a preferred food store of the user using the position information of the user stored as a time series and analyze the eating habit pattern using the selected preferred food store. In addition, the management device may analyze the eating habit pattern of the user based on the movement information and the time and position information of the user. That is, the management device may analyze the mealtime (breakfast, lunch and dinner) of the user using the time information, analyze food stores using the position information, and analyze eating speed using movement of an arm. At this point, the analyzed mealtime, food store, eating speed or the like may be an eating habit pattern.

Then, if a specific time arrives (step S606), the management device creates customized service information according to the eating habit pattern and the health condition of the user and transmits the customized service information to the smart device (step S608). That is, if a lunch time arrives, the management device creates customized service information including coupons or point accumulation of a food store suitable for the user, healthy food coupons and the like based on the eating habit pattern, the preferred food store and the health condition and transmits the customized service information to the smart device.

Then, if information on using the service is received from the smart device (step S610), the management device creates and provides mission information for improving the health condition of the user (step S612). That is, if the user uses a customized service, an additional service is provided by assigning a specific mission, and thus health is naturally managed while using a corresponding service, and the user may get additional benefits.

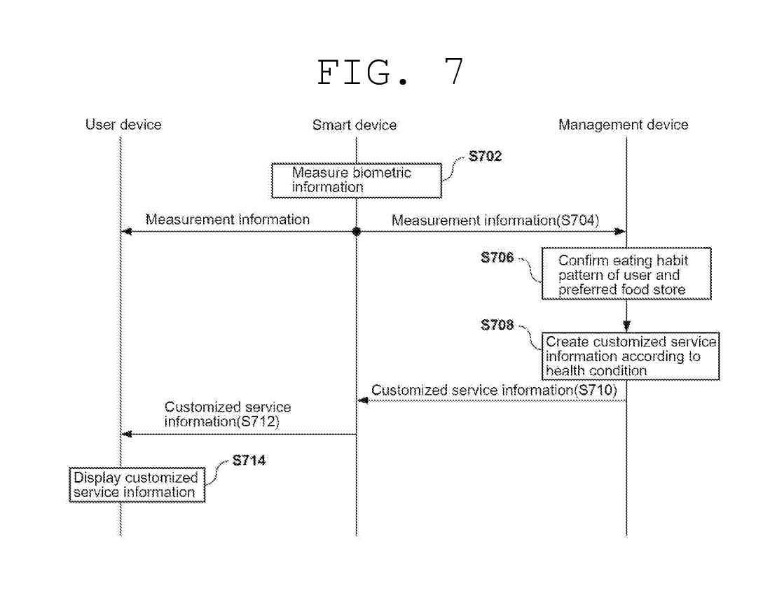

FIG. 7 is a view showing a health management service method based on an eating habit pattern according to another embodiment of the present invention.

Referring to FIG. 7, the smart device measures biometric information and position information of a user (step S702) and transmits measurement information including the measured biometric information and position information to the management device and the user device (step S704). Here, the measurement information may include biometric information, health condition corresponding to the biometric information, position information, smart device identification information, time information and the like. The user device displays the measurement information on the screen.

The management device confirms the eating habit pattern and the preferred food store of the user (step S706) and creates customized service information based on the eating habit pattern, the preferred food store and the health condition (step S708). That is, if a mealtime (a snack time) arrives on the basis of the eating habit pattern, the management device selects a preferred food store preferred by the user or suitable for the health condition of the user. Then, the management device creates customized service information including coupons, points or the like of the selected preferred food store.

The management device transmits the created customized service information to the smart device (step S710), and the smart device transmits the customized service information to the user device (step S712). The user device displays the customized service information (step S714), and the user sees the displayed customized service information and uses a desired service.

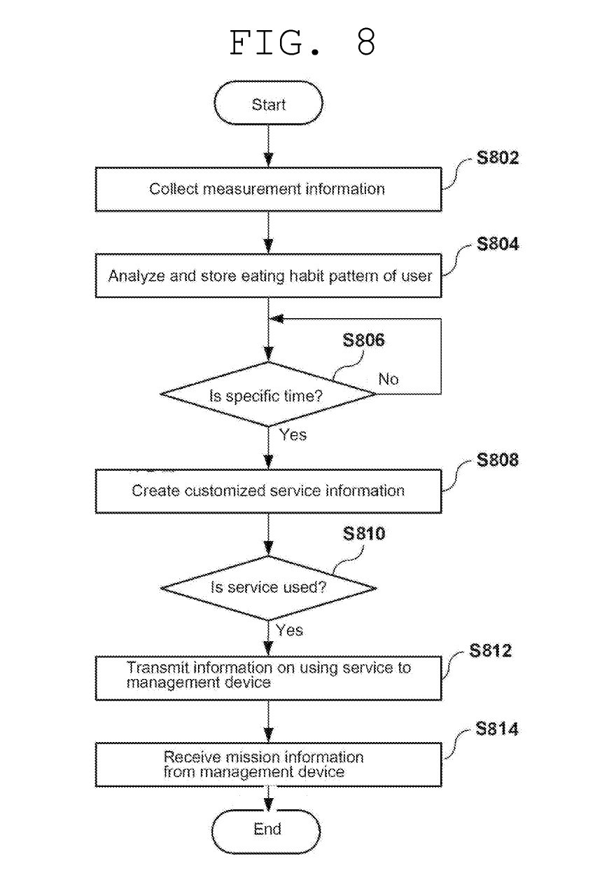

FIG. 8 is a flowchart illustrating a health management service method based on an eating habit pattern by a smart device according to another embodiment of the present invention.

Referring to FIG. 8, the smart device collects measurement information including position information and biometric information (step S802) and analyzes and stores an eating habit pattern of the user using the collected measurement information (step S804). That is, the smart device may select a preferred food store of the user using the position information of the user stored as a time series and analyze the eating habit pattern using the selected preferred food store. In addition, the smart device may analyze the eating habit pattern of the user based on the movement information and the time and position information of the user. That is, the smart device may analyze the mealtime (breakfast, lunch and dinner) of the user using the time information, analyze food stores using the position information, and analyze eating speed using movement of an arm. At this point, the analyzed mealtime, food store, eating speed or the like may be an eating habit pattern.

Then, if a specific time arrives (step S806), the smart device creates and outputs customized service information according to the eating habit pattern and the health condition of the user (step S808). That is, if a lunch time arrives, the smart device creates and outputs customized service information including coupons or point accumulation of a food store suitable for the user, healthy food coupons and the like based on the eating habit pattern, the preferred food store and the health condition.

For example, if the mealtime of the user shows an irregular eating habit pattern, the smart device confirms health condition of the user and provides customized service information such as coupons of food stores for improving health condition of the user at the meal time, coupons for healthy food and the like. In addition, if the blood pressure of the user is high, the smart device may select a store selling food good for the blood pressure among the preferred food stores and provide customized service information such as coupons, point accumulation and the like of the selected store. In addition, if the blood sugar level of the user is high, the smart device may select a store selling food good for the blood sugar among the preferred food stores and provide customized service information such as coupons, point accumulation and the like of the selected store.

Then, if the user uses the customized service information (step S810), the smart device transmits information on using the service to the management device (step S812) and receives mission information from the management device (step S814). If the user performs the mission, the user may receive an additional service.

Such a health management service method based on an eating habit pattern can be created as a computer program, and codes and code segments constituting the computer program may be easily reasoned by a programmer in the art. In addition, the program related to the health management service method based on an eating habit pattern is stored in an information storage medium that can be read by an electronic device and can be read and executed by the electronic device.

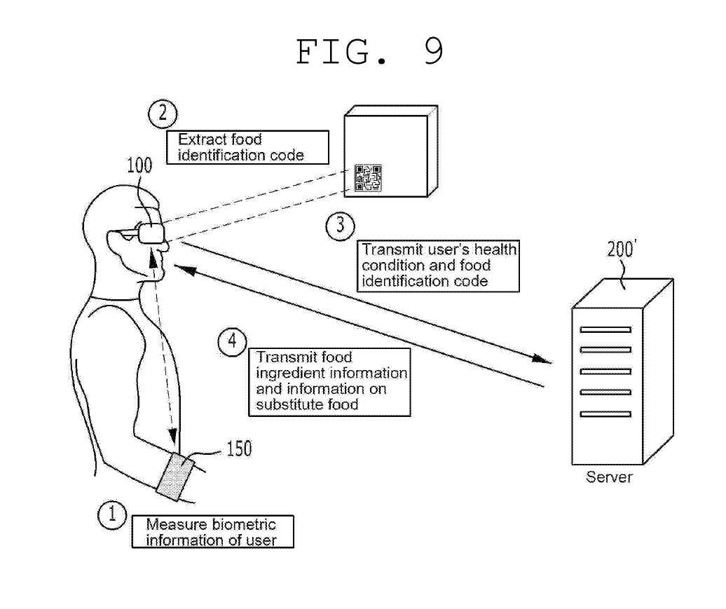

FIG. 9 is a view schematically showing a process of implementing a health management service system based on an eating habit pattern according to an embodiment of the present invention.

Referring to FIG. 9, if the smart device 100′ of the present invention measures health information of a user, such as a disease of the user, physical constitution of the user, biometric information of the user, ingredients harmful to the user and the like, in advance or receives the health information from the user and transmits the health information to the management device 200′ of the present invention, the management device 200′ of the present invention may create a database 210′ of health information of the user. Then, if the user extracts identification information of a food (a food name, a food image, a bar code, a QR code or the like) through the smart device 100′ and transmits the identification information to the management device 200′, the management device 200′ may specify the food based on the identification information, determines whether or not an ingredient that the user should not take is included in the food with reference to the health information of the user stored in the database 210′, and select and provide a substitute food to the smart device 100′ if the food includes the ingredient that the user should not take.

In this specification, since the “management device” may not be equipped with all the functions of a management device generally communicating with a client and may receive information from an external device and provide information to the external device, it is simply named as a management device, and the “management device” generally refers to an apparatus communicating with or included in a smart device 100′ to recommend a food beneficial to the health of a user.

In addition, the ingredient harmful to a user′ means an ingredient that the user cannot take due to a reason of physical constitution or the like of the user, an ingredient that has a bad influence on the health of the user if the user take it or the like, and such ingredients are determined based on the physical constitution, biometric information and the like of the user.

Recently, owing to the advent of various kinds of portable biometric signal measurement sensors, a service of monitoring health condition regardless of time and space is growing. However, although such a service may inform the current health condition, a service of processing the information and informing the user of a dangerous factor is insufficient.

Accordingly, the present invention may create a database 210′ of health information of a user, such as a disease of the user, physical constitution of the user, biometric information of the user, ingredients harmful to the user and the like, in the management device 200′ through a smart device 100′, transmit information on food from the viewpoint of the user to the management device 200′ through the smart device 100′ to distinguish a food harmful to the user, recommend other substitute food beneficial to the health of the user, and provide information on coupons, points and events which can induce purchase of the food.

For example, if a food that the user has transmitted to the management device 200′ through the smart device 100′ is ham ‘A’ (ham of brand ‘A’) and the management device 200′ determines that ham ‘A’ contains ingredients harmful to the user, the management device 200′ may prepare a list of ‘hams’ that do not contain ingredients harmful to the user and inform the user of the list.

In addition, if the food that the user has transmitted to the management device 200′ through the smart device 100′ is ‘ham’ and the management device 200′ determines that the ‘ham’ is a food harmful to the user, the management device 200′ may inform the user of substitute food containing nutritious contents similar to those of ‘ham’, such as chicken, fish, bean meat and the like.

In addition, the management device 200′ transmits information on coupons, points and events to the smart device 100′ or the user device 300′ to induce purchase of other substitute food, and the user may purchase food beneficial to the health of the user using the information.

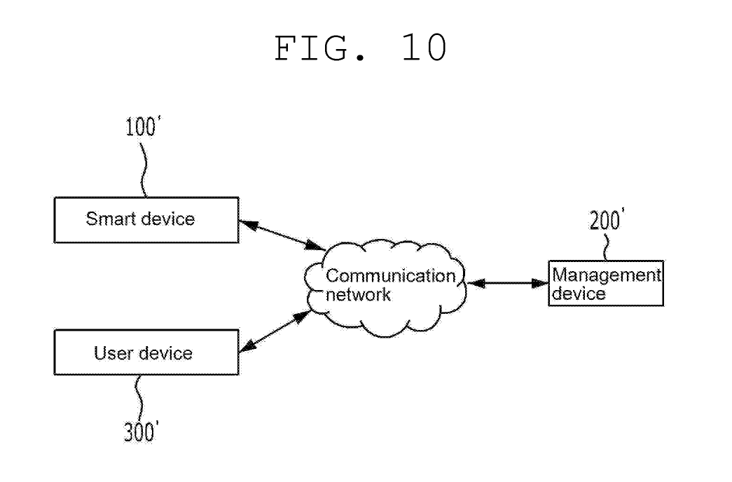

FIG. 10 is a view showing the configuration of a health management service system based on an eating habit pattern according to an embodiment of the present invention.

Referring to FIG. 10, a health management service system based on an eating habit pattern according to an embodiment of the present invention includes a smart device 100′ and a management device 200′. More specifically, the health management service system may include: a smart device 100′ for photographing a food, extracting and transmitting identification information allowing the management device 200′ to specify the photographed food to a management device 200′, and receiving and outputting information on ingredients harmful to the user, contained in a food matching to the identification information, and information on substitute food from the management device 200′; and the management device 200′ for extracting ingredient information of a food matching to the identification information received from the smart device 100′ from the database 210′, extracting information on ingredients that the user cannot take from the food and information on substitute food by comparing the ingredient information of the food with health information of the smart device 100′ user, and transmitting the extracted information to the smart device 100′.

The smart device 100′ is literally a device that can be worn on a human body, and there are various kinds of smart devices according to wearing portions, such as glasses, a watch, shoes, a ring, a belt, a band, a necklace, a headset, clothes and the like.

A wearable device used in the present invention measures health information of a user and specifies and transmits information on food to the management device 200′. Here, the health information may include a disease of the user, physical constitution of the user, biometric information of the user, ingredients harmful to the user and the like. In addition, the biometric information is information on body composition of the user, which can be measured by flowing current through a human body using a principle in which the current flows smoothly through the muscles containing much moisture and the current does not flow smoothly through the fat containing less moisture. Accordingly, body composition can be measured in a method of measuring body water, protein, minerals and fat, which are constitutional components of the body, by measuring a resistance value (impedance) generated when minute current passes through the human body. However, this is merely an example of measuring the body composition, and the body composition can be measured in a variety of method using the smart device 100′.

On the other hand, a conventional apparatus for measuring health information of a user using a smart device 100′ only informs health condition of the user and does not provide a service of informing, based on the measured information, a food which is harmful if the user takes the food and, in addition, recommending a food which can substitute for the harmful food. However, the present invention may create a database 210′ of health information of the user in the management device 200′, transmit information on food from the viewpoint of a user to the management device 200′ through the smart device 100′ to distinguish a food harmful to the user and a food containing ingredients harmful to the user, recommend other substitute food beneficial to the health of the user, and provide information on coupons, points and events which can induce purchase of the food.

In addition, the health management service system based on an eating habit pattern according to another embodiment of the present invention may further include a user device 300′ for receiving information on ingredients that the user cannot take from the food and information on substitute food extracted by the management device 200′, receiving at least one piece of information among information on a store handling the substitute food and information on coupons, points and events from the management device 200′, and making a payment.

The user device 300′ may be, for example, a user device, and the user device includes a Personal Digital Assistant (PDA), a smart phone, a cellular phone, a Personal Communication Service (PCS) phone, a Global System for Mobile (GSM) phone, a Wideband CDMA (W-CDMA) phone, a CDMA-2000 phone, a Mobile Broadband System (MBS) phone, a Portable Multimedia Player (PMP), a Mobile Internet Device (MID), a smart phone, a desktop computer, a tablet computer, a notebook computer, a netbook computer, an information communication device and the like, which can be applied to various wired and wireless environments. Meanwhile, although the user device 300′ may represent a small portable device, embodiments of the present invention will not be specially limited thereto since the user device 300′ can be referred to as a mobile communication terminal if it includes a camcorder, a laptop computer or the like.

Meanwhile, the smart device 100′, the management device 200′ and the user device 300′ preferably transmit and receive information through a communication network.

The communication network includes a base station controller, a base station transmitter and/or a relay. Here, the base station controller performs a function of relaying signals between the base station transmitter and a switching center. The communication network supports both synchronous and asynchronous types. Accordingly, in the case of the synchronous type, the transmitter of a transmission and reception base station will be a Base Station Transmission System (BTS), and the controller of the transmission and reception base station will be a Base Station Controller (BSC), whereas in the case of the asynchronous type, the transmitter of a transmission and reception base station will be a Radio Transceiver Subsystem (RTS), and the controller of the transmission and reception base station will be a Radio Network Controller (RNC). It is apparent that the communication network according to an embodiment of the present invention is not limited thereto, and it generally refers to a GSM network, not a CDMA network, and any one that can be used in an access network of a next-generation mobile communication system which will be implemented in the future.

The communication network may further include access points. The access point is a small base station such as a femto or pico base station frequently installed inside a building. Here, the femto or pico base station is categorized by the maximum number of smart devices 100′ or user devices 300′ based on the classification of small base stations. In addition, the access point includes a short-range communication module for performing short-range communication with a smart device 100′ or a user device 300′, such as Wi-Fi communication or the like. The short-range communication can be performed based on various specifications of Bluetooth communication, Zigbee communication, infrared communication (IrDA), Radio Frequency (RF) communication including Ultra High Frequency (UHF) and Very High Frequency (VHF), Ultra Wide Band (UWB) communication and the like, in addition to the Wi-Fi communication. The access point may extract a position of a data packet, assign a best communication path for the extracted position, and transfer the data packet to a next device, e.g., a smart device 100′ or a user device 300′, along the assigned communication path. The access point may share several circuits in a general network environment.

The access point is largely classified into a fixed access point and a mobile access point. The fixed access point may include a router, a repeater, a relay and the like, and the mobile access point may include a bridge product of a specific manufacturer such as Egg of KT Corporation. Such a mobile access point may read a receiving side address from the transmitting side information and transmit data after assigning a most suitable communication path while guaranteeing free mobility.

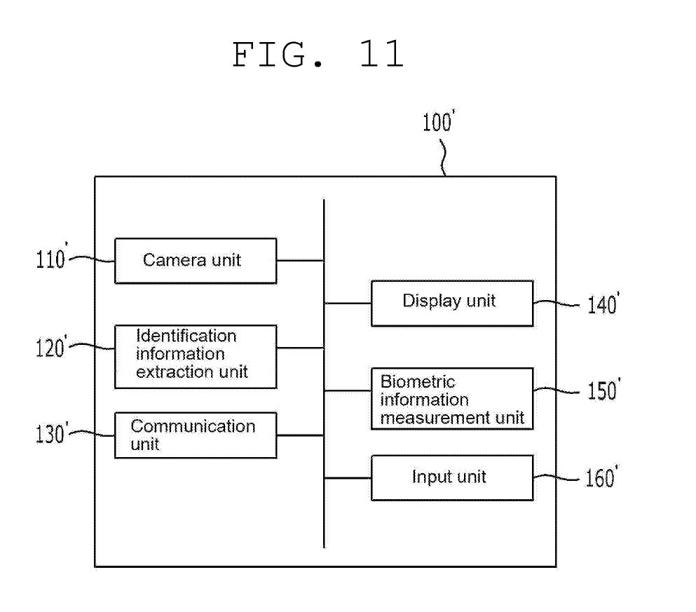

FIG. 11 is a view showing function blocks of a smart device 100′ according to one embodiment of the invention.

Referring to FIG. 11, a smart device 100′ according to an embodiment of the present invention may include: a camera unit 110′ for photographing a food; an identification information extraction unit 120′ for extracting identification information allowing a management device 200′ to specify the photographed food; a communication unit 130′ for transmitting the identification information to the management device 200′ and receiving information on ingredients harmful to the user, contained in a food matching to the identification information, and information on substitute food from the management device 200′; and a display unit 140′ for outputting the received information on ingredients harmful to the user and information on substitute food.

The camera unit 110′ photographs identification information of a food, and a case of photographing identification information of a food by the camera unit 110′ of a smart glass worn on around the eyeballs of a user as shown in FIG. 9 can be considered as an embodiment. If the camera unit 110′ is placed close to the eyeballs of a user, the food is photographed following the eyeline of the user, and thus it is preferable to use a smart device 100′ such as a smart glass.

The identification information extraction unit 120′ may extract identification information allowing the management device 200′ to specify the photographed food. The identification information is a medium containing information which can specify a food and includes a food name printed on the wrap of the food, an image of the food or a food package, a Quick Response (QR) code, a bar code, a logo, a label and the like.

Accordingly, the identification information extraction unit 120′ extracts at least any one of a food name, a food image, a bar code and a QR code from the information photographed by the camera unit 110′ as identification information.

Here, the QR code is a bar code of a matrix type expressing information as a black-white grid pattern, and compared with an existing bar code containing only limited information such as a price, a food name and the like due to constraint of capacity, the QR code has an advantage of containing various kinds of information such as an Internet address (URL) of a long sentence, pictures, ingredient information of a food and the like by making the advantage of enough capacity.

At this point, although identification information may be selected as identification information to be automatically transmitted and transmitted to the management device 200′ if the identification information extraction unit 120′ senses identification information from a food photographed by the camera unit 110′, a method of manually selecting the identification information by the user is also possible. The identification information extraction unit 120′ may display an area determined as a sensing area on the display unit 140′ described below. At this point, if the user selects the area displayed on the display unit 140′, the identification information extraction unit 120′ may select this area as identification information to be transmitted to the management device 200′.

The communication unit 130′ may transmit the identification information to the management device 200′ through a communication network and receive information on ingredients harmful to the user, contained in a food matching to the identification information, and information on substitute food from the management device 200′. Here, the communication network includes both wired communication and wireless communication, and the smart device 100′ and the management device 200′ can be connected to each other through the communication network.

Here, the communication unit 130′ includes an RF transmission means for up-converting the frequency of a transmitted signal and amplifying the signal and an RF reception means for low-noise amplifying a received signal and down-converting the frequency of the received signal. Such a communication unit 130′ may include at least one of a wireless communication module and a wired communication module. In addition, the wireless communication module may include at least one of a wireless network communication module, a Wireless Local Area Network, Wireless Fidelity or Worldwide Interoperability for Microwave Access (WLAN, Wi-Fi or WiMAX) communication module and a Wireless Personal Area Network (WPAN) communication module.

The wireless communication module is a configuration for transmitting and receiving data according to a wireless communication method, and if the smart device 100′ uses wireless communication, it may transmit or receive data to the management device 200′ using any one of the wireless network communication module, the wireless LAN communication module and the wireless PAN communication module.

The wireless network communication module is a configuration for connecting to a communication network through a base station to transmit and receive data. If identification information is received from the identification information extraction unit 120′, the wireless network communication module may connect to a communication network through a base station and transmit the identification information to the management device 200′. In addition, the wireless network communication module may connect to a communication network through a base station, receive information on ingredients harmful to the user and information on substitute food from the management device 200′, and provide the received information to the display unit 140′ described below.

The display unit 140′ may output the information on ingredients harmful to a user and the information on substitute food received from the management device 200′. The display unit 140′ displays information on a series of operation states and operation results created while performing a function of the smart device 100′. In addition, the display unit 140′ may display a menu of the smart device 100′ and user data or the like input by the user. Here, the display unit 140′ may be configured of a Liquid Crystal Display (LCD), a Thin Film Transistor LCD (TFT-LCD), Organic Light Emitting Diodes (OLED), LEDs, Active Matrix Organic LEDs (AMOLEDs), a flexible display, a three-dimensional display or the like. At this point, the display unit 140′ may be configured in the form of a touch screen, and when the display unit 140′ is configured in the form of a touch screen like this, the display unit 140′ may perform some or all of the functions of the input unit 160′ described below. Particularly, the display unit 140′ according to an embodiment of the present invention displays the information on ingredients harmful to the user and the information on substitute food received from the management device 200′.

For example, if a food that the user has transmitted to the management device 200′ through the smart device 100′ is ham ‘A’ and the management device 200′ determines that ham ‘A’ contains ingredients harmful to the user, the management device 200′ may prepare a list of ‘hams’ that do not contain ingredients harmful to the user and inform the user of the list, and the display unit 140′ may output the information and inform the user.

In addition, if the food that the user has transmitted to the management device 200′ through the smart device 100′ is ‘ham’ and the management device 200′ determines that the ‘ham’ is a food harmful to the user, the management device 200′ may transmit substitute food containing nutritious contents similar to those of ‘ham’, such as chicken, fish, bean meat and the like, to the smart device 100′, and the display unit 140′ may output the information and inform the user.

As another embodiment of the present invention, the smart device 100′ may further include a biometric information measurement unit 150′ for measuring biometric information of the user.

The biometric information is information on the body of a user, such as a temperature of the user's body, a heartbeat rate, a blood sugar level, blood pressure, body fat and the like, which can be measured by flowing current through a human body using a principle in which the current flows smoothly through the muscles containing much moisture and the current does not flow smoothly through the fat containing less moisture. Accordingly, body composition can be measured in a method of measuring body water, protein, minerals and fat, which are constitutional components of the body, by measuring a resistance value (impedance) generated when minute current passes through the human body. However, this is merely an example of measuring the body composition, and the body composition can be measured in a variety of method using the smart device 100′.

At this point, the biometric information measurement unit 150′ is mounted on the body of a user to be separated from the other configurations of the smart device 100′ as shown in FIG. 9. At this point, the other configurations of the biometric information measurement unit 150′ and the smart device 100′ are preferably connected through a means of a short-range network. Although the camera unit 110′ is preferably mounted near the eyeballs of the user to photograph a food, it is preferable to mount the camera unit 110′ on the wrist or chest portion of the user to measure the biometric information of the user. To this end, the biometric information measurement unit 150′ may be mounted on a part of the user's body to be separate from the other configurations to measure a biometric signal and transmit the biometric signal to the management device 200′ through a communication network. Therefore, the customized management device 200′ described below may inform the user of a food containing ingredients harmful to the user based on the previously measured biometric information of the user and recommend a food which can substitute for the harmful food.

In addition, the smart device 100′ according to another embodiment of the present invention may further include an input unit 160′ for inputting health information of the user, including any one of a disease of the user, physical constitution and ingredients harmful to the user, as information to be transmitted to the management device 200′ through the communication unit 130′. Therefore, the customized management device 200′ described below may inform the user of a food containing ingredients harmful to the user based on the health information of the user previously input by the user, including the disease of the user, the physical constitution and the ingredients harmful to the user, and recommend a food which can substitute for the harmful food.

In addition, as another embodiment of the present invention, the smart device 100′ may receive information on a store related to substitute food and information on coupons, points and events from the management device 200′ and make a payment.

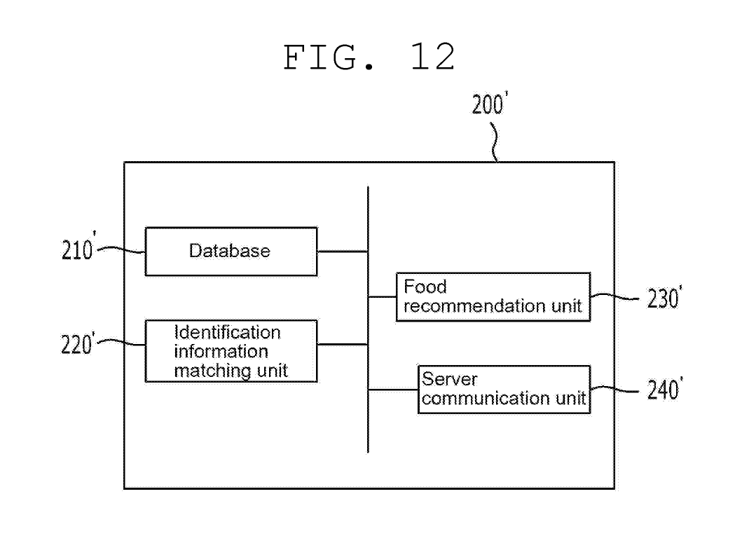

FIG. 12 is a view showing function blocks of a customized management device 200′ according to an embodiment of the invention.

Referring to FIG. 12, a customized management device 200′ according to an embodiment of the present invention may include: a database 210′ for storing health information of a user, including any one of a disease of the user, physical constitution of the user, biometric information of the user and ingredients harmful to the user, ingredient information of a food and identification information specifying the food; an identification information matching unit 220′ for extracting ingredient information of a food matching to the identification information received from the smart device 100′ from the database 210′; a food recommendation unit 230′ for extracting information on ingredients that the user cannot take from the food and information on substitute food by comparing the ingredient information contained in the food with the health information of the smart device 100′ user; and a management device communication unit 240′ for receiving the identification information from the smart device 100′ and transmitting information on ingredients harmful to the user and information on substitute food.

The database 210′ may store health information of the user, including any one of a disease of the user, physical constitution of the user, biometric information of the user and ingredients harmful to the user, ingredient information of a food and identification information specifying the food.

Meanwhile, the health information of the user is received from the smart device 100′ and stored in the database 210′, and the smart device 100′ is attached to the body of the user and measures health information of the user or receives health information directly from the user and transmits the health information of the user to the management device 200′, and the management device communication unit 240′ described below may receive and store the health information in the database 210′.

Accordingly, if certain identification information is received from the smart device 100′, since a food matching to each identification information is stored in the database 210′, a food information matching unit described below may extract information on the food matching to the received identification information and ingredient information of the food from the database 210′.

Here, the database 220 is an apparatus for storing data and basically stores data such as environmental variables or the like used for search, classification, analysis and the like, and since the functions of the database 220 can be implemented using general techniques, detailed descriptions on the implementation will be omitted.

The identification information matching unit 220′ extracts ingredient information of the food matching to the identification information received from the smart device 100′ from the database 210′. Here, the identification information is a medium containing information which can specify a food and includes a food name printed on the wrap of the food, an image of the food or a food package, a Quick Response (QR) code, a bar code, a logo, a label and the like.

The food recommendation unit 230′ extracts information on ingredients that the user cannot take from the food and information on substitute food by comparing the ingredient information of the food with health information of the smart device 100′ user.

Since the food information stored in the database 210′ stores food ingredients that each of the food information contains, the food recommendation unit 230′ may extract ingredient information of the food transmitted from the smart device 100′. Accordingly, if all the ingredients contained in the food can be taken by the user, the food recommendation unit 230′ may send a signal informing that the user may eat the food to the smart device 100′, and if an ingredient harmful to the user is contained in the food, the harmful ingredient among the ingredients contained in the food is transmitted, and substitute food can be searched and transmitted.

In addition, if the food received from the smart device 100′ contains ingredients harmful to the user, the food recommendation unit 230′ selects a food containing ingredients other than the harmful ingredients as much as possible as a substitute food. At this point, since the food information stored in the database 210′ stores food ingredients that each of the food information contains, if the food contains an ingredient harmful to the user, the food recommendation unit 230′ may search and extract substitute food containing other ingredients as much as possible without containing the ingredient harmful to the user.

For example, if a food transmitted by the smart device 100′ is ‘ham A’ and the food recommendation unit 230′ of the management device 200′ determines that ‘ham A’ contains ingredients harmful to the user, the food recommendation unit 230′ may prepare a list of ‘hams’ that do not contain ingredients harmful to the user and inform the user of the list.

In addition, if the food received from the smart device 100′ is a food unsuitable for the disease or physical constitution of the user, the food recommendation unit 230′ selects a substitute food containing nutritious contents similar to those of the food. At this point, since the food stored in the database 210′ stores nutritious contents information, the food recommendation unit 230′ may extract substitute food by comparing nutritious contents of each food.

For example, if a food selected by the user is ‘ham’ and the food recommendation unit 230′ determines that the ‘ham’ is a food harmful to the user, the food recommendation unit 230′ may inform the user of substitute food containing nutritious contents similar to those of ‘ham’, such as chicken, fish, bean meat and the like.

In addition, the food recommendation unit 230′ extracts at least one of information on a store handling the substitute food and information on coupons, points and events. At this point, the management device communication unit 240′ described below may transmit the information to the smart device 100′ or the user device 300′.

Accordingly, the smart device 100′ or the user device 300′ may receive information on ingredients that the user cannot take from the food and information on substitute food extracted by the customized management device 200′ and make a payment using information on a store handling the substitute food and information on coupons, points and events.

The management device communication unit 240′ may receive identification information from the smart device 100′ and transmit information on ingredients harmful to the user of the smart device 100′ and information on substitute food to the smart device 100′ or the user device 300′ through a communication network. Here, the communication network includes both wired communication and wireless communication, and the smart device 100′ and the management device 200′ can be connected to each other through the communication network.

Here, the communication unit 130′ includes an RF transmission means for up-converting the frequency of a transmitted signal and amplifying the signal and an RF reception means for low-noise amplifying a received signal and down-converting the frequency of the received signal. Such a communication unit 130′ may include at least one of a wireless communication module and a wired communication module. In addition, the wireless communication module may include at least one of a wireless network communication module, a Wireless Local Area Network, Wireless Fidelity or Worldwide Interoperability for Microwave Access (WLAN, Wi-Fi or WiMAX) communication module and a Wireless Personal Area Network (WPAN) communication module.

The wireless communication module is a configuration for transmitting and receiving data according to a wireless communication method, and if the management device 200′ uses wireless communication, it may transmit or receive data to and from the smart device 100′ or the user device 300′ using any one of the wireless network communication module, the wireless LAN communication module and the wireless PAN communication module.

The wireless network communication module is a configuration for connecting to a communication network through a base station to transmit and receive data. If information on ingredients that the user should not take and information on substitute food are received from the recommendation unit 230′, the wireless network communication module may connect to a communication network through a base station and transmit the information to the smart device 100′ or the user device 300′.

Hereinafter, a health management service system, a smart device 100′ and a management device 200′ based on an eating habit pattern will be described from the viewpoint of a method. Meanwhile, since details of each step of a health management service method based on an eating habit pattern described below have been handled in the embodiments related to the device of the present invention, duplicated descriptions will be omitted.

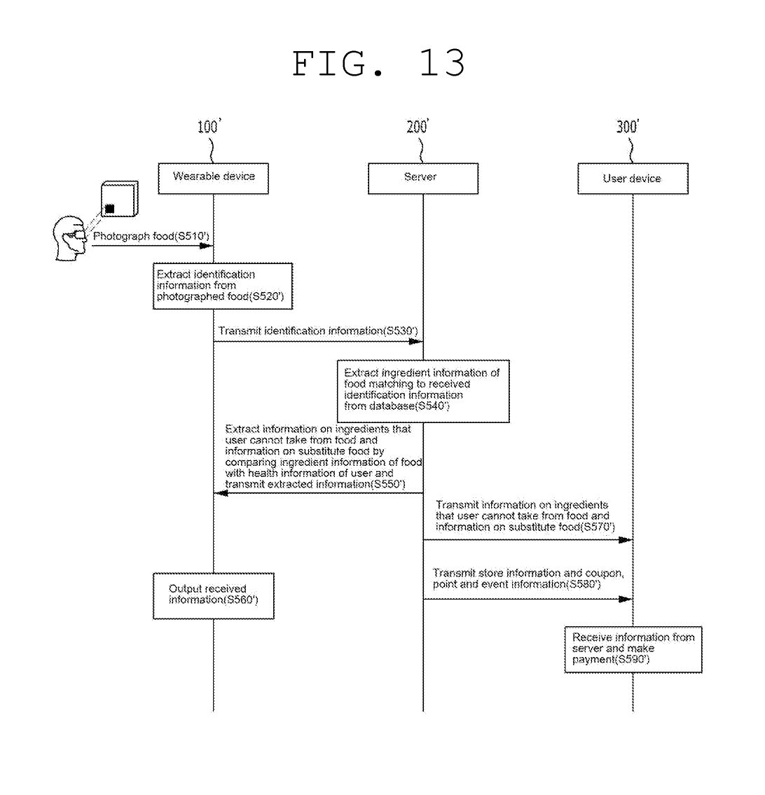

FIG. 13 is a flowchart illustrating a health management service method based on an eating habit pattern according to another embodiment of the present invention.

Referring to FIG. 13, a health management service method based on an eating habit pattern of the present invention may include the steps of: (a) photographing a food by a smart device 100′ (step S510′); (b) extracting, by the smart device 100′, identification information allowing the management device 200′ to specify the photographed food (step S520′); (c) transmitting, by the smart device 100′, the identification information to the management device 200′ (step S530′); (d) extracting, from the database 210′ by the management device 200′, ingredient information of a food matching to the identification information received from the smart device 100′ (step S540′); (e) extracting, by the management device 200′, information on ingredients that the user cannot take from the food and information on substitute food by comparing the ingredient information of the food with health information of the smart device 100′ user (step S550′); and (f) outputting, by the smart device 100′, the received information on ingredients harmful to the user and information on substitute food (step S560′).

At this point, the health management service method based on an eating habit pattern of the present invention may further include, after step (e), the steps of: transmitting, by the management device 200′, the information on ingredients that the user cannot take from the food and the information on substitute food (step S570′); transmitting, by the management device 200′, at least one piece of information among information on a store handling the substitute food and information on coupons, points and events (step S580′); and receiving, by the user device 300′, the information and making a payment (step S590′).

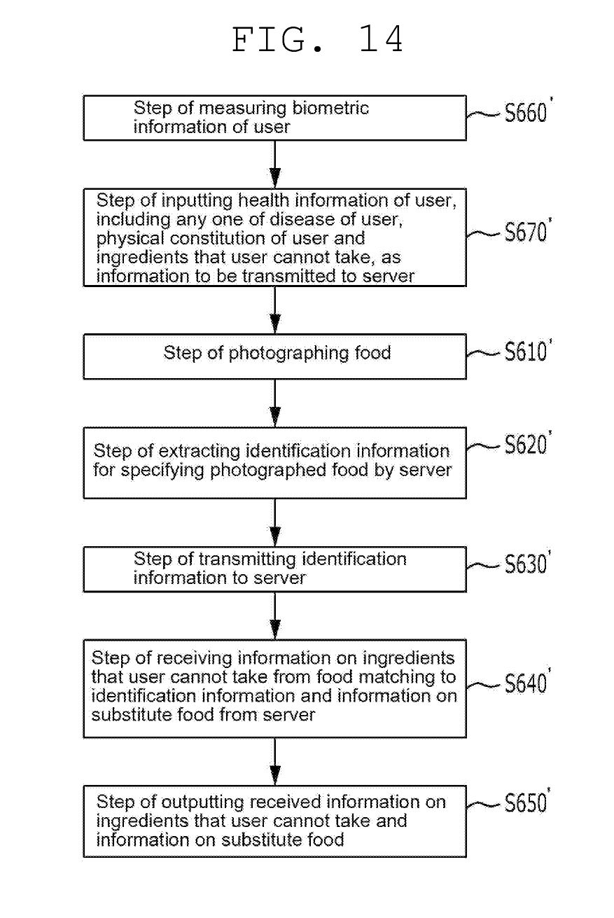

FIG. 14 is a flowchart illustrating a health management service method based on an eating habit pattern in a smart device 100′ according to another embodiment of the present invention.

Referring to FIG. 14, a health management service method based on an eating habit pattern in the smart device 100′ of the present invention may include the steps of: (a) photographing a food (step S610′); (b) extracting identification information allowing the management device 200′ to specify the photographed food (step S620′); (c) transmitting the identification information to the management device 200′ (step S630′); (d) receiving information on ingredients harmful to the user, contained in a food matching to the identification information, and information on substitute food from the management device 200′ (step S640′); and (e) outputting the received information on ingredients harmful to the user and information on substitute food (step S650′).

At this point, step (b) (step S620′) extracts at least any one of a food name, a food image, a bar code and a QR code.

In addition, the customized method in the smart device 100′ may further include the step of measuring biometric information of the user (step S660). However, step S660′ is not limited to a time series sequence, but the biometric information of the user can be measured and transmitted to the management device at any time.

At this point, the step of measuring the biometric information of the user mounts the biometric information measurement unit 150′ on the body of a user to be separate from the other configurations of the smart device 100′.

In addition, the biometric information is at least one of temperature, heartbeat rate, blood sugar level, blood pressure and body fat.

In addition, the customized method in the smart device 100′ may further include the step of inputting health information of the user, including any one of a disease of the user, physical constitution, biometric information and ingredients harmful to the user, as information to be transmitted to the management device 200′ (step S670). However, step S670′ is not limited to a time series sequence, but the health information of the user can be input and transmitted to the management device at any time.

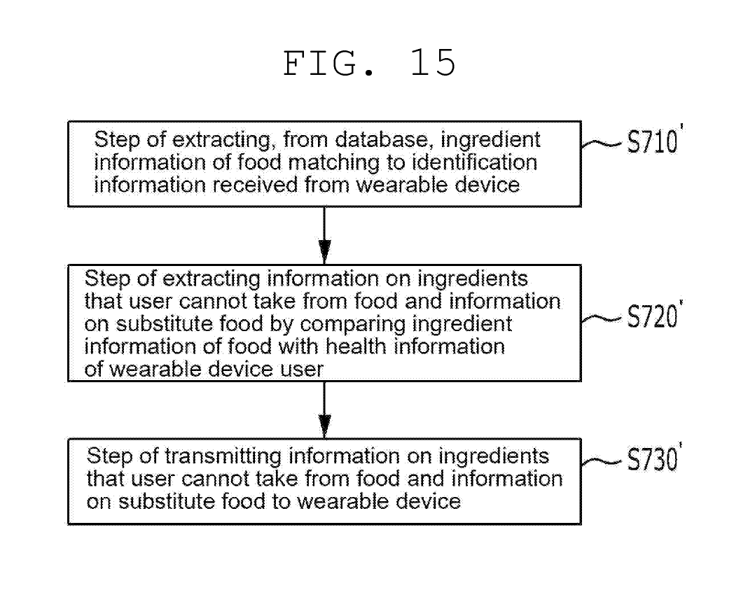

FIG. 15 is a flowchart illustrating a health management service method based on an eating habit pattern in a management device 200′ according to another embodiment of the present invention.

Referring to FIG. 15, a health management service method based on an eating habit pattern in a management device 200′ of the present invention may include the steps of: (a) extracting, from the database 210′, ingredient information of a food matching to identification information received from the smart device 100′ (step S710′); (b) extracting information on ingredients that the user cannot take from the food and information on substitute food by comparing the ingredient information of the food with health information of the smart device 100′ user (step S720′); and (c) transmitting information on ingredients harmful to the user and the information on substitute food (step S730′).

At this point, the identification information is at least any one of a food name, a food image, a bar code and a QR code.

In addition, if the food contains ingredients harmful to the user, step (b) (step S720′) selects a food containing ingredients other than the harmful ingredients as much as possible as a substitute food.

In addition, if the food is a food unsuitable for the disease or physical constitution of the user, step (b) (step S720′) selects a substitute food containing nutritious contents similar to those of the food.

In addition, step (b) (step S720′) extracts at least one of information on a store handling the substitute food and information on coupons, points and events.

Like this, those skilled in the art may recognize that the present invention can be embodied in other specific forms without departing from the spirit and essential characteristics of the present invention. Therefore, it should be understood that the embodiments described above are illustrative and not restrictive to limit the scope. In addition, the flowcharts in the figures show sequential orders exemplarily shown to achieve the most desirable results in implementing the present invention, and it is apparent that other additional steps can be provided or some steps can be deleted.

Technical features described in this specification and implementations executing the features can be implemented in digital electronic circuitry, or in computer software, firmware or hardware including the structures disclosed in this specification and their structural equivalents, or in combinations of one or more of them. In addition, the implementations executing the features described in this specification can be implemented as one or more computer program products, i.e., one or more modules of computer program instructions encoded on a tangible program carrier for execution by, or to control the operation of, a data processing device.

A computer-readable medium can be a machine-readable storage device, a machine-readable storage substrate, a memory device, a composition of matter effecting a machine-readable propagated signal, or any combination thereof.

The term “device” or “system” in the specification encompasses all instruments, devices and machines for processing data, including a processor, a computer or multiple processors or computers. The processing system may include, in addition to hardware, a code that creates an execution environment for the computer program if requested, e.g., a code constituting processor firmware, a protocol stack, a database management system, an operating system, or any combination thereof.

A computer program also referred to as a program, software, a software application, a script or a code can be written in any form of programming language including compiled or interpreted languages, or declarative or procedural languages, and can be implemented in any form including as a standalone program or a module, a component, a subroutine or other units suitable for use in a computing environment.

Meanwhile, a computer program does not necessarily correspond to a file in a file system. A program can be stored in a single file or multiple coordinated files (e.g., files that store one or more modules, sub-programs, or portions of a code) provided in the requested program or in a portion of a file that holds other programs or data (e.g., one or more scripts stored in a markup language document).

A computer program can be implemented to be executed on multiple computers or one or more computers located at one site or distributed across multiple sites and interconnected by a wired/wireless communication network.

Meanwhile, the computer-readable media suitable for storing computer programs, instructions and data may include all forms of non-volatile memory, media and memory devices including by way of example semiconductor memory devices, e.g., EPROM, EEPROM, and flash memory devices; magnetic disks, e.g., internal hard disks or external disks; magneto-optical disks; and CD and DVD disks. Further, the processor and memory can be supplemented by, or incorporated in, special purpose logic circuitry.

The implementations executing the features described in this specification can be implemented in a computing system that includes a back end component, e.g., a data server, or that includes a middleware component, e.g., an application server, or that includes a front end component, e.g., a client computer having a Web browser or a graphical user interface through which a user can interact with an implementation of the subject matter described in this specification, or any combination of one or more of the back end, middleware or front end components. The components of the system can be interconnected by any form or medium of digital data communication, e.g., a communication network.

Hereinafter, a further specific embodiment for implementing configurations including the system described in this specification together with the above-described contents and an MO (mobile originated) service-based benefic providing method will be described in detail.

The system and the health management service method based on an eating habit pattern described in this specification may be partially or entirely used through a means executing computer software, program codes or instructions on a server related to a client device or a web-based storage system or one or more processors included in the server. Here, the processor may be part of a computing platform such as a server, a client, a network infrastructure, a mobile computing platform, a fixed computing platform or the like, and specifically, it can be a kind of a computer or a processing device which can execute program instructions, codes or the like. In addition, the processor may further include memory for storing the health management service method based on an eating habit pattern, instructions, codes and programs, and if the memory is not included, the processor may access, through a separate interface, a storage device such as a CD-ROM, a DVD, memory, a hard disk, a flash drive, RAM, ROM cache or the like in which the health management service method based on an eating habit pattern, instructions, codes and programs are stored.

In addition, the system and the health management service method based on an eating habit pattern described in this specification may be partially or entirely used through a machine that executes computer software on a server, a client, a gateway, a hub, a router or network hardware. The software may be executed in various kinds of servers such as a file server, a print server, a domain server, an Internet server, an Intranet server, a host server, a distributed server and the like, and the servers may further include memories, processors, computer-readable storage media, storage media, communication devices, ports, clients and interfaces capable of accessing other servers through a wired/wireless network.

The health management service method based on an eating habit pattern, instructions, codes and the like also can be executed by a server, and other devices required for execution of the health management service method based on an eating habit pattern can be implemented as a part of a hierarchical structure associated with the server.

In addition, the server may provide an interface to other devices including, without limitation, clients, other servers, printers, database servers, print servers, file servers, communication servers, distributed servers and the like, and a connection through the interface may facilitate remote execution of a program through a wired/wireless network.

In addition, any one of the devices attached to the server through an interface may further include at least one storage device capable of storing the health management service method based on an eating habit pattern, instructions, codes and the like, and the central processor of the server may provide the device with instructions, codes and the like to be executed on different devices to be stored in the storage device.

On the other hand, the system and the health management service method based on an eating habit pattern described in this specification may be partially or entirely used through a network infrastructure. Here, the network infrastructure may include all of devices such as computing devices, servers, routers, hubs, firewalls, clients, personal computers, communication devices, routing devices and the like, separate modules capable of executing each of the functions and the like and may further include a storage medium such as flash memory, a buffer, a stack, RAM, ROM and the like in addition to the devices and modules mention above. In addition, the health management service method based on an eating habit pattern, instructions, codes and the like also can be executed and stored by any one of the devices, modules and storage media included in the network infrastructure, and other devices needed to execute the health management service method based on an eating habit pattern also can be implemented as a part of the network infrastructure.

In addition, the system and the health management service method based on an eating habit pattern described in this specification may be implemented in hardware or a combination of hardware and software suitable for a particular application. Here, the hardware may include all of general purpose computer devices such as a personal computer, a mobile communication device and the like and specific computer devices for enterprise, and the computer device may be implemented as a device including memory, microprocessors, microcontrollers, digital signal processors, application integrated circuits, programmable gate arrays, programmable array organizations (→logic) and the like or a combination thereof.

The computer software, instructions, program codes and the like described above may be stored or accessed by a readable device. Here, the readable device may include memory such as: computer components that retains digital data used for computing for some interval of time; semiconductor storage such as RAM or ROM; permanent storage such as optical disks; mass storage such as hard disks, tapes, drums or the like; optical storage such as CD or DVD; computer-detachable mass storage such as flash memory, floppy disks, magnetic tapes, paper tapes, standalone RAM disks or the like; network connection storage such as dynamic memory, static memory, variable storage or clouds, and the like. Meanwhile, although the instructions, codes or the like include all the languages including data-oriented languages (e.g., SQL, dBase), system languages (e.g., C, Objective-C, C++, Assembly), architectural languages (e.g., Java, .NET), and application languages (e.g., PHP, Ruby, Perl, Python), they are not limited thereto and include all other languages known to those of skill in the art.

In addition, the term “computer-readable medium” described in this specification includes all the media contributing to providing instructions for execution of a program to a processor. Specifically, the medium includes, but not limited to, non-volatile media such as data storage devices, optical disks, magnetic disks and the like, volatile media such as dynamic memory and the like, and transmission media such as coaxial cables, copper wires, fiber optics and the like for transmitting data.

Meanwhile, the elements executing the technical features of the present invention, which are included in the block diagrams and flowcharts shown in the drawings attached to this specification, imply logical boundaries between the elements.

However, according to software or hardware embodiments, since the depicted elements and the functions thereof may be executed in the form of a standalone software module, a monolithic software structure, a code, a service and a combination of these and stored in a medium executable in a computer provided with a processor capable of executing stored program codes, instructions and the like to implement their functions, all such implementations may be regarded as being included within the scope of the present invention.

Thus, while the attached drawings and descriptions thereof set forth technical features of the present invention, no particular arrangement of software for implementing these functional aspects should be inferred from these descriptions unless explicitly stated or otherwise clear from the context. That is, there may exist various embodiments described above, and since part of the embodiments can be modified while possessing technical features the same as those of the present invention, all the modifications should be regarded as being included within the scope of the present invention.

While operations are depicted in the drawings in a particular order, this is shown to achieve the most desirable results should not be construed as requiring that such operations should be performed in the particular order shown or in a sequential order or that all the illustrated operations should be performed. In certain circumstances, multitasking and parallel processing may be advantageous. Moreover, separation of various system components in the embodiments described above should not be understood as requiring such separation in all embodiments, and it should be understood that the described program components and systems can generally be integrated together in a single software product or packaged into multiple software products.

As described above, this specification is not intended to limit the present invention by the proposed specific terms. Accordingly, although the present invention has been described in detail with reference to the embodiments described above, those skilled in the art may make alterations, changes and modifications on the embodiments without departing from the scope of the present invention.

The scope of the present invention is represented by the claims to be described below rather than the detailed description, and it is to be interpreted that the meaning and scope of the claims and all the changes or modified forms derived from the equivalents thereof come within the scope of the present invention.

According to the present invention, health of a user can be managed and convenience in using a service can be pursued by confirming health condition of the user through a smart device and providing a customized service based on the health condition and eating habit patterns.

In addition, an eating habit pattern of a user can be managed by analyzing the eating habit pattern of the user using information measured by a smart device.

In addition, if the user uses a customized service, an additional service is provided by assigning a specific mission, and thus health is naturally managed while using a corresponding service, and the user may get additional benefits.

In addition, through successive missions, the problem of the user's health can be preferentially improved.

The present invention may create a database of health information of a user, such as a disease of the user, physical constitution of the user, biometric information of the user, ingredients harmful to the user and the like, in the management device through a smart device, transmit information on food from the viewpoint of the user to the management device through the smart device to distinguish a food harmful to the user, recommend other substitute food beneficial to the health of the user, and provide information on coupons, points and events which can induce purchase of the food.

The effects of the present invention are not limited to the effects mentioned above, and various effects can be included within the scope clearly understood by those skilled in the art from the above descriptions.

What is claimed is:

1. A management device comprising:
a communication unit for communicating with a smart device;
an eating habit pattern analysis unit for selecting a preferred food store of a user using position information according to movement of the smart device, and analyzing and storing an eating habit pattern using the selected preferred food store; and
a customized service unit for creating customized service information based on the eating habit pattern and health condition transmitted from the smart device and transmitting the created customized service information to the smart device.

2. The management device according to claim 1, wherein the eating habit pattern analysis unit analyzes the eating habit pattern based on user's body movement information and time and position information transmitted from the smart device.

3. A smart device comprising:
a camera unit for photographing a food;
an identification information extraction unit for extracting identification information allowing a server to specify the photographed food;
a communication unit for transmitting the identification information to the server and receiving information on substitute food of a food matching to the identification information from the server; and
a display unit for outputting the received information on substitute food.

4. The smart device according to claim 3, wherein the identification information extraction unit extracts at least any one of a food name, a food image, a bar code and a QR code as the identification information.

5. The smart device according to claim 3, further comprising an input unit for inputting health information of a user, including any one of a disease of the user, physical constitution and ingredients harmful to the user, as information to be transmitted to the server by the communication unit.

6. A customized management device comprising:
a database for storing health information of a user, including any one of a disease of the user, physical constitution of the user, biometric information of the user and ingredients harmful to the user, ingredient information of a food and identification information specifying the food;
an identification information matching unit for extracting, from the database, ingredient information of a food matching to the identification information received from a wearable device;
a food recommendation unit for extracting information on ingredients contained in the food and harmful to the user and information on substitute food by comparing the ingredient information of the food with the health information of the wearable device user; and
a server communication unit for receiving the identification information from the wearable device and transmitting the information on substitute food.

7. The management device according to claim 6, wherein the identification information is at least any one of a food name, a food image, a bar code and a QR code.

8. The management device according to claim 6, wherein if the food contains an ingredient harmful to the user, the food recommendation unit selects a food containing ingredients other than the harmful ingredient as much as possible as a substitute food.

9. The management device according to claim 6, wherein if the food is a food unsuitable for the disease or the physical constitution of the user, the food recommendation unit selects a substitute food containing nutritious contents similar to those of the food.

10. The management device according to claim 8, wherein the food recommendation unit extracts at least one of information on a store handling the substitute food and information on coupons, points and events.
